(19) United States
(12) Patent Application Publication
(10) Pub. No.: US 2022/0207036 A1
(43) Pub. Date: Jun. 30, 2022

(54) DATA ACCESS METHOD AND APPARATUS, AND DATA STORAGE METHOD AND APPARATUS

(71) Applicant: TENCENT TECHNOLOGY (SHENZHEN) COMPANY LIMITED, Shenzhen (CN)

(72) Inventors: Xiao OU, Shenzhen (CN); Dongqing HUANG, Shenzhen (CN); Junjian LIU, Shenzhen (CN); Jiandong LI, Shenzhen (CN)

(21) Appl. No.: 17/696,576

(22) Filed: Mar. 16, 2022

Related U.S. Application Data
(63) Continuation of application No. PCT/CN2020/124253, filed on Oct. 28, 2020.

(30) Foreign Application Priority Data
Mar. 20, 2020 (CN) 202010199062.5

(51) Int. Cl. G06F 16/2458; G06F 16/27; G06F 16/23

(52) U.S. Cl. CPC G06F 16/2471; G06F 16/2379; G06F 16/275

(57) ABSTRACT

A data operation method includes: parsing, in response to receiving a data read request, the data read request to obtain a query condition; querying data satisfying the query condition in a not only structured query language (NoSQL) database (DB) when the query condition satisfies a preset high-frequency access condition; querying data satisfying the query condition in a relational DB when the query condition satisfies a preset complex access condition, data stored in the NoSQL DB and the relational DB being consistent; responding to the data read request based on the queried data.

### CROSS-REFERENCES TO RELATED APPLICATIONS

This application is a continuation application of PCT Patent Application No. PCT/CN2020/124253, entitled “DATA ACCESS METHOD AND APPARATUS, AND DATA STORAGE METHOD AND DEVICE” and filed on Oct. 28, 2020, which claims priority to Chinese Patent Application No. 202010199062.5, filed to the CNIPA on Mar. 20, 2020 and entitled “DATA ACCESS METHOD AND APPARATUS, AND DATA STORAGE METHOD AND APPARATUS”, the entire contents of both of which are incorporated herein by reference.

### FIELD OF THE TECHNOLOGY

The present disclosure relates to the technical field of databases (DBs), and particularly to a data access method and apparatus and a data storage method and apparatus.

### BACKGROUND OF THE DISCLOSURE

Massive data is generated every day in the Internet. In order to manage massive data effectively, Internet service providers mostly store generated data in DBs. At present, MySQL, Oracle and other relational DBs are mainly used to store data. A relational DB uses a structured query language to query data, and supports addition, deletion, modification and query operations over data in the DB as well as a cross-table query function. The relational DB is convenient to use and easy to understand, and thus is applied more and more extensively.

However, the relational DB stores data in form of a single data table. The performance limitation of reading and writing a single table cannot be adapted to increasing data access, affects normal data access, and gradually becomes the bottleneck of business development.

### SUMMARY

One aspect of the present disclosure provides a data operation method. The method includes: parsing, in response to receiving a data read request, the data read request to obtain a query condition; querying data satisfying the query condition in a not only structured query language (NoSQL) database (DB) when the query condition satisfies a preset high-frequency access condition; querying data satisfying the query condition in a relational DB when the query condition satisfies a preset complex access condition, data stored in the NoSQL DB and the relational DB being consistent; responding to the data read request based on the queried data.

The data operation method may also include: parsing, in response to receiving a data write request, the data write request to obtain data to be written; writing the data to be written in a first DB, the first DB being one of the NoSQL DB and the relational DB; synchronizing the data to be written from the first DB to a second DB, the second DB being the other one of the NoSQL DB and the relational DB; and responding to the data write request based on a write result of the data to be written.

Another aspect of the present disclosure provides a data access apparatus, which includes: a data read request module, configured to parse, in response to receiving a data read request, the data read request to obtain a query condition; a data query module, configured to query data satisfying the query condition in a NoSQL DB when the query condition satisfies a preset high-frequency access condition, and querying data satisfying the query condition in a relational DB when the query condition satisfies a preset complex access condition, data stored in the NoSQL DB and the relational DB being consistent; and a query result feedback module, configured to respond to the data read request based on the queried data.

Another aspect of the present disclosure provides a computer device, which includes a memory storing a computer-readable instruction and one or more processors, the computer-readable instruction, when executed by the processors, causing the one or more processors to execute the steps of the data operation method.

Another aspect of the present disclosure provides one or more non-transitory computer-readable storage media storing computer-readable instructions are provided, the computer-readable instructions, when executed by one or more processors, causing the one or more processors to execute: parsing, in response to receiving a data read request, the data read request to obtain a query condition; querying data satisfying the query condition in a not only structured query language (NoSQL) database (DB) when the query condition satisfies a preset high-frequency access condition; querying data satisfying the query condition in a relational DB when the query condition satisfies a preset complex access condition, data stored in the NoSQL DB and the relational DB being consistent; responding to the data read request based on the queried data.

### BRIEF DESCRIPTION OF THE DRAWINGS

To describe the technical solutions in the embodiments of the present disclosure more clearly, the following briefly describes accompanying drawings required for describing the embodiments. Apparently, the accompanying drawings in the following description show merely some embodiments of the present disclosure, and a person skilled in the art may still derive other drawings from these accompanying drawings without creative efforts.

FIG. 1 is a diagram of an application environment of data access and storage methods according to an embodiment.

FIG. 2 is a flowchart of a data access method according to an embodiment.

FIG. 3 is a schematic principle diagram of a data access method according to an embodiment.

FIG. 4 is a schematic diagram of a master-slave protection mechanism-based relational DB according to an embodiment.

FIG. 5 is a flowchart of a data access method according to an embodiment.

FIG. 6 is a flowchart of a data storage method according to an embodiment.

FIG. 7 is a schematic principle diagram of a data storage method according to an embodiment.

FIG. 8 is a flowchart of performing quasi-real-time synchronization between a relational DB and a NoSQL DB in response to a data update request according to an embodiment.

FIG. 9 is a flowchart of performing quasi-real-time synchronization between a relational DB and a NoSQL DB in response to a data insertion request according to an embodiment.

FIG. 10 is a flowchart of backlog reconciliation in a relational DB and a NoSQL DB according to an embodiment.

FIG. 11 is a flowchart of a data storage method according to an embodiment.

FIG. 12 is a structural schematic diagram of a data access apparatus according to an embodiment.

FIG. 13 is a structural schematic diagram of a data access apparatus according to another embodiment.

FIG. 14 is a structural schematic diagram of a data storage apparatus according to an embodiment.

FIG. 15 is a structural schematic diagram of a data storage apparatus according to another embodiment.

FIG. 16 is an internal structure diagram when a data service device is implemented as a server according to an embodiment.

### DESCRIPTION OF EMBODIMENTS

To make the objectives, technical solutions, and advantages of the present disclosure clearer and more understandable, the present disclosure is further described in detail below with reference to the accompanying drawings and the embodiments. It is to be understood that the specific embodiments described herein are only used for explaining the present disclosure, and are not used for limiting the present disclosure.

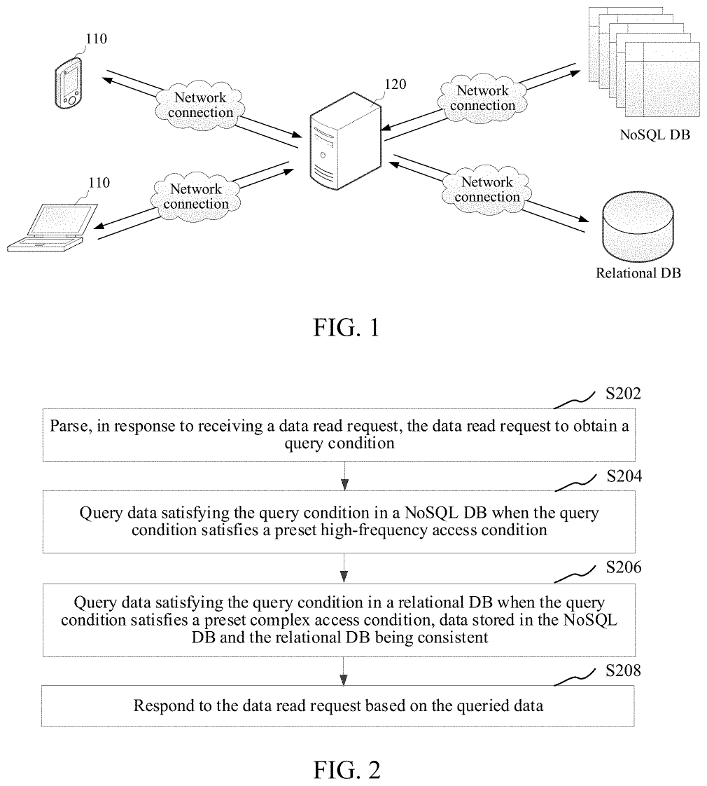

The data access method and the data storage method provided in the present disclosure may be applied to an application environment shown in FIG. 1. A data access device 110 is connected with a data service device 120 directly or indirectly in a wired or wireless communication mode. The data service device 120 is provided with a corresponding DB 130. The DB 130 includes a relational DB 130a and a NoSQL DB 130b. One or more NoSQL DBs 130b may be deployed. A data access party may initiate a data read request or a data write request to the data service device 120 through the data access device 110. The data service device 120 provides data scheduling service for the data access party, queries data in the relational DB 130a or the NoSQL DB 130b according to the data read request, or writes data in the relational DB 130a and the NoSQL DB 130b according to the data write request in a manner of ensuring the data consistency between the relational DB 130a and the NoSQL DB 130b.

The data access device 110 may specifically be a terminal, a server, or a combination of a terminal and a server. For example, the data access party initiates a data read request to a server through a terminal, and the server forwards the data read request to the data service device 120. The data service device 120 may be a server. The terminal may be specifically a smartphone, a tablet computer, a notebook computer, a desktop computer, a smart speaker, a smartwatch, or the like, but is not limited thereto. The server may be specifically an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

In an embodiment, a data access method is provided, as shown in FIG. 2. Taking the application of the method to the data service device 120 in FIG. 1 as an example, the following steps are included:

Step 202: Parse, in response to receiving a data read request, the data read request to obtain a query condition.

A target Application (APP) capable of executing the data access method and data storage method provided in the present disclosure, e.g., a social APP, a payment APP and a game APP, is run in a data access device. The target APP may specifically be a parent APP (also called a Mini program). The parent APP may be a native APP, or a web page accessed based on page browsing references. The data read request may be a data request initiated by a data access party through the target APP in the data access device to instruct the data service device to perform a read operation on data in a DB. The query condition is a query field input by the data access party through the target APP when initiating the data read request.

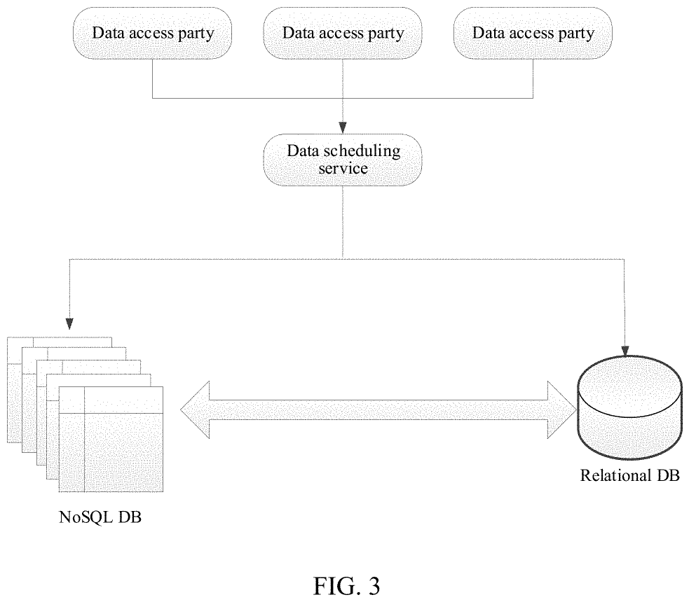

Specifically, referring to FIG. 3, a schematic principle diagram of a data access method according to an embodiment is shown.

As shown in FIG. 3, when data needs to be queried, the data access party may set a query condition based on the target APP in the data access device. The query condition may include one or more query fields. The target APP generates a data read request according to the query field and send the data read request to the data service device. The data service device is provided with a corresponding DB. The data service device, after receiving the data read request, parses the data read request to obtain the query condition, and provides data scheduling service for the data access party according to the query condition.

Step 204: Query data satisfying the query condition in a NoSQL DB when the query condition satisfies a preset high-frequency access condition.

A DB, also known as a data management system, may be regarded as an electronic filing cabinet in short, i.e., a place where an electronic file is stored, and a user may perform operations such as addition, extraction, updating and deletion on data in the file. The “DB” is a set of data stored together in such a manner that the data may be shared by multiple users, with as little redundancy as possible, independent of APPs. A general DB refers to a data storage carrier in informatization. The DB may be classified into a relational DB and a NoSQL DB according to different data storage structures.

The NoSQL DB eliminates relational features of the relational DB and stores mutually independent data. Such independence makes the NoSQL DB simple in structure, high in read-write performance and capable of meeting high-frequency access requirements. An aggregation model is used for processing in the NoSQL DB. The aggregation model mainly includes Key-Value, BSON, column family, document, graphic, and other modes. The NoSQL DB used in the embodiment of the present disclosure is mainly a key-value storage DB. The key-value storage DB stores data as a Key-Value set. Key points to Value as a unique Identifier (ID). Value is unstructured and usually regarded as a string or binary data. How to explain is defined by the user.

The key-value storage DB may specifically be KV (also called Ktable, a distributed storage system), remote dictionary server (Redis), DynamoDB, Apache Cassandra, etc. KV, as a distributed storage system developed by Tencent WeChat, includes a KV server and a KV client, and provides a set of structured data semantic DBs, such as data manipulation interfaces Select, Update, Insert and Delete like SQL. Redis is an open-source logged key-value storage DB written in ANSI C language and based on the web, an internal memory or a nonvolatile memory, and provides application programming interfaces (APIs) of multiple languages. Redis supports many value types to be stored, including string, list, set, zset (sorted set), hash, etc.

In practical applications, a data access scene may be divided into a simple access scene and a complex access scene according to the complexity of query condition. The simple access scene needs a high-frequency data read-write operation according to a main ID of a data record. The complex access scene needs a dataset satisfying multiple conditions to be screened according to multiple attribute contents of a data record, thereby performing a read-write operation. Both scenes often occur in business scenes of a large number of target APPs. The occurrence frequencies of the two scenes and requirements thereof on a data layer are different. In the simple access scene, the access frequency is high, and data records need to be screened according to unique IDs of data only. In the complex access scene, the access frequency is not high, but the data layer is required to provide a capability of screening a range according to multiple field conditions.

A preset high-frequency access condition is a preset index for determining a current data read request as a data request from a simple high-frequency access scene, and may specifically be that the query condition includes only one query field which is a unique ID of a data record (i.e., a query primary key), that a data channel used when the data access party initiates the data read request is a first channel, etc. A preset complex access condition is a preset index for determining a current data read request as a data request from a complex low-frequency access scene, and may specifically be that the query condition includes more than one query field, that a data channel used when the data access party initiates the data read request is a second channel, etc.

Specifically, the target APP provides multiple access channels, such as a first channel and a second channel, on a data access page. When the data access party inputs a query field to initiate a data read request based on a button of the first channel, the data service device determines the data read request as a request satisfying the preset high-frequency access condition according to a first channel ID in the data read request. As shown in FIG. 3, when the query request satisfies the preset high-frequency access condition, the data service device generates a query statement corresponding to the query condition according to a preset access syntax rule of the NoSQL DB, such as extensible markup language (XML), and queries data satisfying the query condition in the NoSQL DB based on the query statement.

Step 206: Query data satisfying the query condition in a relational DB when the query condition satisfies a preset complex access condition, data stored in the NoSQL DB and the relational DB being consistent.

The relational DB refers to a DB that uses a relational model to organize data, and stores the data in form of rows and columns so as to make it convenient for the user to understand. The series of rows and columns of the relational DB are called a table. A set of tables form the DB. The data in each row of the table forms a record. The data in each record is related. The user may retrieve the data in the DB by defining one or more query fields. For example, the number of girls with scores of 80 to 90 may be queried in a student information table by defining fields of “score” and “gender”. The relational model may be simply understood as a two-dimensional table model. A relational DB is a data set including two-dimensional tables and relationships therebetween. Mainstream relational DBs include Oracle, DB2, MySQL, Microsoft SQL Server, Microsoft Access, etc.

In general, a relational DB supports low-concurrency data access operations, and may provide a capability of screening data according to a complex query condition including multiple query fields. A NoSQL DB support high-concurrency data access operations, and may provide a capability of screening data according to a unique query primary key Key for distributed storage.

Specifically, when the data access party inputs a query field to initiate a data read request based on a button of the second channel, the data service device determines the data read request as a request satisfying the preset complex access condition according to a second channel ID in the data read request. As shown in FIG. 3, when the query request satisfies the preset complex access condition, the data service device generates a query statement corresponding to the query condition according to a preset access syntax rule of the relational DB, such as SQL, and queries data satisfying the query condition in the relational DB based on the query statement.

In an embodiment, the data access method further includes the following operations: it is determined that the query condition satisfied the preset high-frequency access condition when the query condition is a routing field; and it is determined that the query condition satisfies the preset complex access condition when the query condition includes a query field that is not the routing field.

In the NoSQL DB, each of Key and Value may be any content from a simple object to a complex object, but Key is the only primary key capable of identifying the data. For example, when the user logs in a social APP for conversation, the social APP may store all related session data in a NoSQL DB. The session data may include user information, messages, personalized data, subjects, suggestions, targeted promotions and discounts, etc. Each user session has a unique ID, i.e., a unique primary key capable of identifying the session data in the NoSQL DB. The routing field is a data ID serving as a basis for distributed storage in the NoSQL DB, i.e., a unique query primary key capable of identifying data in the NoSQL DB.

The data service device determines whether the query field in the query condition is a routing field. If YES, the data service device determines that the query condition satisfies the preset high-frequency access condition. When the query condition includes another query field that is not the routing field, namely the query condition includes multiple query fields, or the query condition includes only one query field but the query field is not a routing field, the data service device determines that the query condition satisfies the preset complex access condition.

As shown in the following table 1, in the present embodiment, data is queried in the NoSQL DB based on a unique data ID in the simple high-frequency access scene. Data is queried in the relational DB based on multiple query fields in the complex access scene.

TABLE 1

| | Operation | | |
|---|---|---|---|
| Access scene | frequency | Screening range | Queried DB |
| Simple access | High frequency | Routing field | NoSQL DB |
| Complex access | Low frequency | Including one | Relational DB |
| | | or more query | |
| | | fields that is | |
| | | not the routing | |
| | | field | |

In the embodiment of the present disclosure, data stored in the relational DB and the NoSQL DB is consistent (e.g., contents stored in the two DBs are generally the same). Therefore, it is ensured that the data identified from any one of the DBs is consistent. In an embodiment, consistency check may be performed periodically or aperiodically on the data in the relational DB and the NoSQL DB, and a data synchronization process is performed when the data is inconsistent, so as to ensure the consistency of the data in the relational DB and the NoSQL DB.

Step 208: Respond to the data read request based on the queried data.

Specifically, the data service device transmits data identified from the relational DB or the NoSQL DB to the data access device in response to the data read request. The data access party performs a data access operation directly through data scheduling service provided by the data service device, without regard to the implementation details thereof.

In the data access method, the relational DB supports low-concurrency data access operations, and may provide a capability of screening data according to a complex query condition. The NoSQL DB supports high-concurrency data access operations, and may provide a capability of screening data according to a simple query condition. By combining the advantages of the two storage technologies and ensuring the consistency of the data in the two DBs, sources for querying data are distinguished according to the data access scene. That is, data is queried in the NoSQL DB in a high-concurrency data access scene, and data may be queried in the relational DB in a low-concurrency data access scene with a complex query condition. Therefore, both a high-concurrency data access request and a complex data access request may be satisfied, and the data access performance is improved.

In an embodiment, the NoSQL DB includes multiple distributed sub-DBs. The operation that data satisfying the query condition is queried in a NoSQL DB when the query condition satisfies a preset high-frequency access condition includes the following operations: when the query condition is a routing field, a distributed interval the routing field belongs to is determined; and data satisfying the query condition is queried in a distributed sub-DB configured to store data in the distributed interval.

The NoSQL DB is highly partitionable and allows horizontal extension on scales unachievable for other types of DBs. If existing partitions are full and more storage spaces are needed, the NoSQL DB may allocate an additional partition to tables, thereby implementing distributed storage. In general, the NoSQL DB may support the distributed storage of massive data.

The NoSQL DB includes multiple distributed sub-DBs. A distributed interval is a value range of a routing field of data stored in each distributed sub-DB during the distributed storage of the NoSQL DB. For example, if a data ID (i.e., routing field) of each piece of data is a user ID, data of every 100 users may be stored in a distributed sub-DB. For example, data of users [ID0, ID100] is stored in distributed sub-DB A1, and data of users [ID101, ID200] is stored in distributed sub-DB A2.

The data service device queries data in the NoSQL DB when it is determined that the query condition satisfies the preset high-frequency access condition. Specifically, the data service device determines a distributed interval the routing field in the query condition belongs to, further determines a distributed sub-DB for storing data in the distributed interval, and queries data satisfying the query condition in the determined distributed sub-DB.

In the present embodiment, compared with centralized storage, distributed storage may improve data security. In addition, data query based on the distributed sub-DB may reduce data processing in data query, thereby improving the data query efficiency.

In an embodiment, there is one or more NoSQL DBs. The operation that data satisfying the query condition is queried in a NoSQL DB when the query condition satisfies a preset high-frequency access condition includes the following operation: when the query condition is a routing field, data satisfying the query condition is queried in a DB of the one or more NoSQL DB that uses the routing field as a distributed storage basis.

As described above, each NoSQL DB has a corresponding routing field based on which a high-concurrency access request may be initiated to the corresponding NoSQL DB. If high-concurrency access is desired for multiple fields, a NoSQL DB corresponding to each field may be deployed. For example, NoSQL DBs A and B may take fields A and B as routing fields respectively. It may be understood that data contents stored in each NoSQL DB are consistent, except that different fields are used as routing fields. Each relational DB may include multiple distributed sub-DBs.

Specifically, after it is determined that the data read request is from a high-frequency access scene, if there are multiple NoSQL DBs, the data service device further determines a specific NoSQL DB where data is queried according to a specific NoSQL DB corresponding to a routing field the query field belongs to. For example, in the above-mentioned example, data may be queried in NoSQL DB A when a data read request only including query field A is subsequently received. Data may be queried in NoSQL DB B when a data read request only including query field B is subsequently received.

In the present embodiment, corresponding NoSQL DBs may be distributed and deployed for different subdivided high-frequency access scenes to simultaneously satisfy data access requests of multiple high-frequency access scenes.

In an embodiment, the relational DB includes a master DB and at least one slave DB. The operation that data satisfying the query condition is queried in a relational DB includes the following operations: a query request is initiated to the master DB based on the query condition; one of the slave DBs is determined as a current master DB when no query response of the master DB to the query request is received within a preset time; and data satisfying the query condition is queried in the current master DB.

In addition to data access performance, data availability is also critical. A highly available DB is an overall system of a series of DBs, and requires at least one DB node to be able to respond to a data access request of a user and provide data services at any time. The relational database stores data centrally in a single data table, and requires high data security, so a highly available master-slave backup mechanism is used for relational DBs. A highly available relational DB system includes a master DB and at least one slave DB. The master DB is used for responding to a data access request initiated by a data access party and synchronizing data write operation information of the data access party to the slave DB. The slave DB is used for backing up the data in the master DB. It may be understood that both the master and slave DBs are relational DBs.

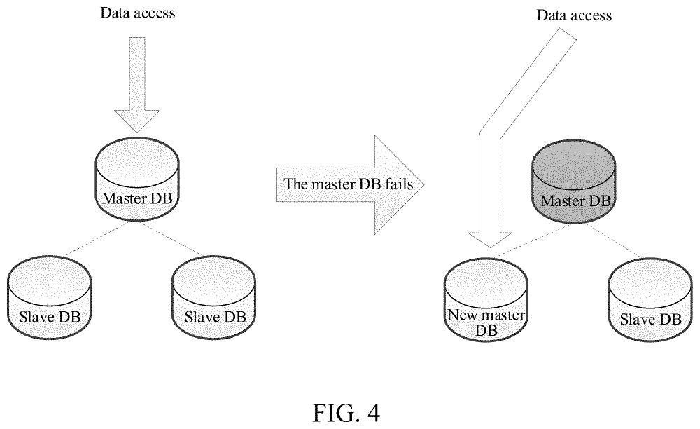

Specifically, after determining that the data read request is from a complex access scenario, the data service device queries data in the master DB of the relational DB system, namely transmitting a query request to the master DB according to the query condition. The data service device determines that the master DB fails if not receiving a query response of the master DB to the query request within a preset time. Referring to FIG. 4, a schematic diagram of a master-slave protection mechanism-based relational DB according to an embodiment is shown. As shown in FIG. 4, when the master DB fails, the data service device randomly determines a slave DB as a new master DB, or determines a slave DB with the best current performance as a new master DB, etc., and then queries data satisfying the query condition in the current master DB.

In an embodiment, the data service device initiates a query request to the master DB again if not receiving a query response of the main DB to the query request within a preset. After a preset number of retries, it is determined that the master DB fails if no responses to all of the preset number of query requests are received.

In an embodiment, the NoSQL DB may improve the data security according to the above-mentioned master-slave backup mechanism. Since the NoSQL DB uses distributed storage, a corresponding backup DB corresponding to each distributed sub-DB may be deployed. It may be understood that both the backup DB and the distributed sub-DB are NoSQL DBs.

In the present embodiment, there is a master DB for processing main data access requests and a plurality of backup slave DBs for disaster-tolerance switching. When the master DB may not provide service, the backup slave DB may automatically continue to provide service as a master DB. Therefore, the availability and stability of the whole relational DB system may be ensured.

In an embodiment, the data access method further includes the following operations: a log generated during a write operation over the master DB is acquired; the log is transmitted to one or more target slave DBs so that the target slave DBs synchronously execute the write operation according to the log; and in case of receiving synchronization acknowledgment information returned by the target slave DBs after the write operation, the log is transmitted to the other slave DBs based on successful write in response to a data write request used for triggering the write operation.

In addition to continuous and stable data service, data consistency between the master DB and the slave DB needs to be ensured. According to the embodiment of the present disclosure, the data consistency between the master DB and the slave DB is ensured based on a log replication data synchronization mode. The log replication data synchronization mode refers to sending a data operation over the master DB to each slave DB in form of a log and performing the same data operation immediately after the slave DB receives the log, so as to complete data backup. The data operation includes a read operation and a write operation. The write operation includes an update operation, an insertion operation, etc. In the log replication data synchronization mode, the master DB is connected with the at least one slave DB, so that read and write may be separated conveniently. In addition, each slave DB is in operation, data in the slave DB is hot data, and disaster-tolerance switching may be implemented quickly.

The log replication data synchronization mode may specifically be any one of asynchronous replication, semisynchronous replication, and fully synchronous replication. The asynchronous replication refers to that the master DB, after sending a newly generated log to each slave DB, considers that synchronization has been completed without waiting for acknowledgment reply information of the slave DB, and feeds back information that the data operation succeeds to the data access party. DBs such as MySQL uses asynchronous replication by default. The asynchronous replication may improve accelerate the data operation and reduce the time consumption, but reduces the data reliability. In such an extreme case that the master DB fails when the master DB just submits a log and has yet not received a related log from another slave DB, the master DB fails, since the master DB has returned the information that the data operation succeeds to the data access party, all data operation contents of the log are lost.

The fully synchronous replication refers to that the master DB, after sends a newly generated log to each slave DB, considers that synchronization is completed only after receiving acknowledgment reply information of all the slave DBs. The fully synchronous replication may ensure the data reliability, but seriously affects the data operation rate.

As a data synchronization mode between the asynchronous replication and the fully synchronous replication, the semisynchronous replication refers to that the data service device needs to send a log to a preset number of target slave DBs before sending a newly generated log of the master DB to each master DB, and after the slave DBs return acknowledgment information, the data service device submits the log to the other slave DBs, and it is directly considered that synchronization is completed. The target slave DB may be any slave DB or a pre-specified slave DB. The preset number may be set freely to be, for example, 1, as required. It may be understood that, if the preset number is larger, more time is needed by data synchronization, and the data reliability is higher. When the preset number is 1, it may be ensured that the information that the data operation succeeds is returned to the data access party only when at least one slave DB has really completed synchronization, so as to ensure the data reliability. For the other slave DBs, it is considered that the synchronization of the slave DBs is completed immediately when logs are sent out according to the asynchronous replication. Therefore, the time consumption is reduced.

In the semisynchronous replication mode, since the information that the data operation is completed is not returned to the data access party if no acknowledgment reply information is received from the target slave DB, the data access party needs to repeat the data operation to further trigger a log replication in such an extreme case that the master DB fails when the master DB just submits a log and has yet not received a related log from another slave DB. Therefore, in such an extreme case, the semisynchronous replication may ensure the data reliability and avoid data loss during disaster-tolerance switching.

In the present embodiment, the log-based master-slave semisynchronous replication mode for the data synchronization between the master DB and the slave DB may also ensure the data consistency between the master DB and different slave DBs. The semisynchronous replication mode may improve the data reliability compared with the asynchronous replication mode, and compared with the fully synchronous replication mode, may reduce the time consumption effectively and improve the DB operation efficiency.

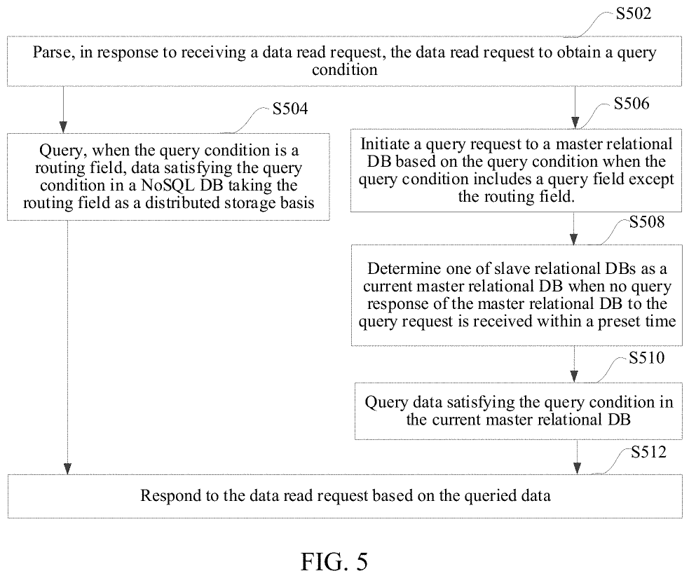

In one embodiment, as shown in FIG. 5, the data access method includes the following steps:

S502: Parse, in response to receiving a data read request, the data read request to obtain a query condition.

S504: Query, when the query condition is a routing field, data satisfying the query condition in a DB of the one or more NoSQL DB that uses the routing field as a distributed storage basis.

S506: Initiate a query request to a master relational DB based on the query condition when the query condition includes a query field that is not the routing field.

S508: Determine one of slave relational DBs as a current master relational DB when no query response of the master relational DB to the query request is received within a preset time.

S510: Query data satisfying the query condition in the current master relational DB.

S512: Respond to the data read request based on the queried data.

In the data access method, the relational DB supports low-concurrency data access operations, and may provide a capability of screening data according to a complex query condition. The NoSQL DB supports high-concurrency data access operations, and may provide a capability of screening data according to a simple query condition. By combining the advantages of the two storage technologies and ensuring the consistency of the data in the two DBs, sources for querying data are distinguished according to the data access scene. That is, data is queried in the NoSQL DB in a high-concurrency data access scene, and data may be queried in the relational DB in a low-concurrency data access scene with a complex query condition. Therefore, both a high-concurrency data access request and a complex data access request may be satisfied, and the data access performance is improved.

It is to be understood that, although the steps in the flowcharts of FIG. 2 and FIG. 5 are sequentially displayed according to indication of arrows, the steps are not necessarily sequentially performed in the sequence indicated by the arrows. Unless clearly specified in this specification, there is no strict sequence limitation on the execution of the steps, and the steps may be performed in another sequence. Moreover, at least some of the steps in FIG. 2 and FIG. 5 may include a plurality of steps or a plurality of stages. These steps or stages are not necessarily performed at the same moment, but may be performed at different moments. These steps or stages are not necessarily performed sequentially, but may be performed in turn or alternately with at least one part of other steps or steps or stages of the other steps.

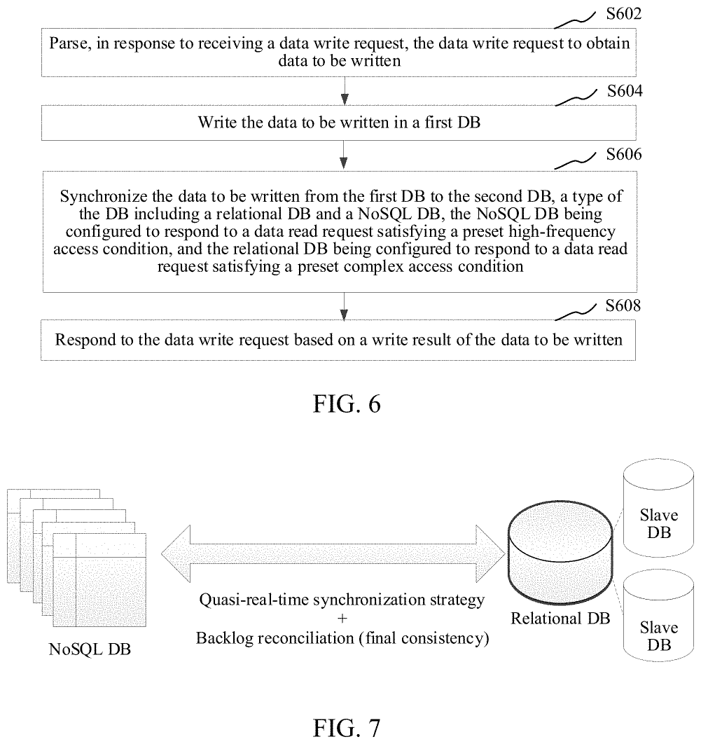

In an embodiment, a data storage method is provided, as shown in FIG. 6. Taking the application of the method to the data service device 120 in FIG. 1 as an example, the following steps are included:

Step 602: Parse, in response to receiving a data write request, the data write request to obtain data to be written.

The data write request is a data request initiated by a data access party through a target APP in a data access device to instruct the data service device to perform a write operation on data in a DB. The write operation includes an update operation, an insertion operation, etc. The update operation refers to a modification or deletion operation over the data. The deletion operation usually configures a validity field of data to be invalid by updating rather than actually deletes data from the DB.

Specifically, the data access party, when needing to write data in a DB, may input the data to be written based on the target APP in the data access device. The target APP generates a data write request according to the data to be written and sends the data write request to the data service device. The data service device parses the data write request to obtain the data to be written and provides data scheduling service for the data access party according to the data to be written.

Step 604: Write the data to be written in a first DB.

Step 606: Synchronize the data to be written from the first DB to a second DB, a type of the DB including a relational DB and a NoSQL DB, the NoSQL DB being configured to respond to a data read request satisfying a preset high-frequency access condition, and the relational DB being configured to respond to a data read request satisfying a preset complex access condition.

An operation over data in the DB includes a read operation and a write operation. Reading data may not change the data, and thus does not need data synchronization between the relational DB and the NoSQL DB. The write operation may change data, and thus needs a data synchronization operation between the relational DB and the NoSQL DB to ensure the data consistency. An example synchronization strategy may be writing data to be written in a first DB (e.g., the first DB being one of the NoSQL DB and the relational DB) and then synchronizing the data to be written from the first DB to a second DB (e.g., the second DB being the other one of the NoSQL DB and the relational DB). For example, during an update operation, the data to be written may be updated to the NoSQL DB at first, and then the relational DB is updated according to the NoSQL DB. For another example, during an insertion operation, the data to be written may be inserted into the relational DB at first, and then the NoSQL DB is updated according to the relational DB.

Referring to FIG. 7, a schematic principle diagram of a data storage method according to an embodiment is shown. As shown in FIG. 7, data synchronization may be performed on the relational DB and the NoSQL DB based on a quasi-real-time synchronization strategy. The data synchronization operation between the relational DB and the NoSQL DB is driven by a write operation event. In other words, once a data write request is initiated, data to be written is written in a DB immediately and then synchronized to another DB. Such an event-driven data synchronization strategy may make small a time interval for the synchronization between the relational DB and the NoSQL DB, and may implement no real-time but quasi-real-time synchronization. The event-driven data synchronization strategy is a quasi-real-time synchronization strategy.

Step 608: Respond to the data write request based on write result of the data to be written.

The write result refers to result information indicating whether the data to be written has been successfully written in the DB, specifically including successful write and unsuccessful write. Write results of different write operations may further be distinguished as an update result, an insertion result, etc. According to a determination rule of the write result, the write result may be determined to be successful write when the data to be written is successfully written in one DB, or the written result may be determined to be successful write only when the data to be written is successfully written in both DBs.

Specifically, the data service device returns the write result to the data access party after determining the write result of the data to be written according to the determination rule of the written result. For example, during an update operation, information that the data is successfully updated may be returned to the data access party immediately when the data to be written is successfully updated to the NoSQL DB. For another example, during an insertion operation, the data to be written may be inserted into the relational DB at first, then the NoSQL DB is updated according to the relational DB, and information that the data is successfully inserted is returned to the data access party when the data to be written is successfully inserted into the relational DB and the NoSQL DB.

In the data storage method, during a data write operation, data is written in a first DB at first, and then is synchronized from the first DB to the second DB. Since the data in the DB is obtained by synchronization, the consistency of the data in the two DBs may be ensured. Since the write and synchronization of the data are driven by a data write operation event, the real-time performance of data synchronization may be ensured. The relational DB supports low-concurrency data access operations, and may provide a capability of screening data according to a complex query condition. The NoSQL DB supports high-concurrency data access operations, and may provide a capability of screening data according to a simple query condition. On the premise of ensuring the consistency of the data in the two DBs, the advantages of the two storage technologies may be combined to distinguish sources for querying data according to the data access scene. That is, data is queried in the NoSQL DB in a high-concurrency data access scene, and data may be queried in the relational DB in a low-concurrency data access scene with a complex query condition. Therefore, both a high-concurrency data access request and a complex data access request may be satisfied, and the data access performance is improved.

In an embodiment, the data to be written includes data ID and a target data content. The operation that the data to be written is written in a DB includes the following operation: an original data content corresponding to the data ID in the NoSQL DB is updated according to the target data content when the data write request is a data update request. The operation that the data to be written is synchronized from the DB to another DB includes the following operation: the target data content is asynchronously updated from the NoSQL DB to the relational DB by messagequeuing (MQ) after the update of the NoSQL DB.

The data update request is a data request for instructing the data service device to execute an update operation on the data in the DB. MQ refers to an APP-to-APP communication method. APPs communicate by writing and retrieving queued data (messages) for the APPs, and need not to be linked by dedicated connections. Messaging refers to communicating between APPs by sending data in messages, rather than communicating with each other by direct calling, which is typically used for technologies such as remote procedure calling. Queuing refers to communication of an APP through a queue. The use of queues eliminates the requirement for simultaneous execution of receiving and sending APPs.

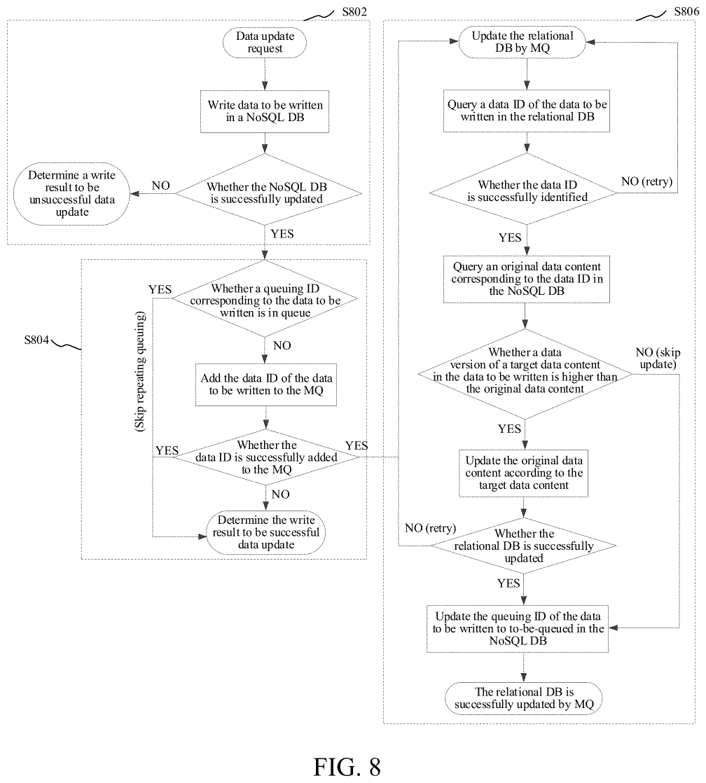

Specifically, referring to FIG. 8, a flowchart of performing quasi-real-time synchronization between a relational DB and a NoSQL DB in response to a data update request according to an embodiment is shown. As shown in FIG. 8, the step of responding to a data update request includes the following steps:

S802: When receiving a data update request, the data service device determines data needing to be updated (hereinafter referred to as target data) in the NoSQL DB according to the data ID of the data to be written in the data update request so as to replace an original data content of the data with the target data content in the data to be written. Due to downtime, etc., the target data may fail to be updated in the NoSQL DB. In such case, information that the data fails to be updated is fed back to the data access party.

S804: After completing the update of the target data in the NoSQL DB, the data service device generates an update task according to the data to be written or the data ID thereof, and adds the update task to the MQ.

S806: The data service device performs the update task to update the target data in the relational DB. For example, the data to be written is added to the MQ, and the data service device extracts the data to be written from the MQ for consumption as required, namely updating the target data in the relational DB according to the extracted data to be written.

In the present embodiment, the NoSQL DB is updated first, and then the relational DB is updated asynchronously by means of the MQ. Such an update operation time-driven data synchronization strategy can make small a time interval for the synchronization between relational DB and the non-relational DB, and may implement quasi-real-time synchronization.

In an embodiment, the operation that the target data content is asynchronously updated from the NoSQL DB to the relational DB by MQ includes the following operations: the data ID of the data to be written is added to the MQ when a queuing ID corresponding to the data to be written is to-be-queued, and the queuing ID is updated to in-queue in the NoSQL DB; data IDs in the MQ are traversed according to a queuing sequence; and a corresponding target data content is queried in the NoSQL DB according to a currently traversed data ID, an original data content corresponding to the data ID in the relational DB is updated according to an identified target data content, and a queuing ID corresponding to the currently traversed data ID is updated to to-be-queued.

The queuing ID is a field added to the DB by the data service device to execute the data access and storage methods provided by the present disclosure. Each piece of data has a corresponding queuing ID. In order to avoid that the high-frequency update generates a large number of queuing operations leading to an out-of-MQ length range and further the loss of the update task, a queuing ID field is introduced in the embodiment of the present disclosure, which is marked at the NoSQL DB side. The queuing ID field needs only be added to the data table of the NoSQL DB. The queuing ID is used to characterize state information about whether an update task of a piece of data is located in the MQ, and specifically includes “to-be-queued” and “in-queue”.

Specifically, as shown in FIG. 8, the operation in step S804 that the update task is added to the MQ includes the following operation: the data service device determines a queuing marker corresponding to the data ID of the data to be written in the NoSQL DB. In an embodiment, the queuing ID may also be characterized by another character. For example, “to-be-queued” may be characterized by 0, and “in-queue” may be characterized by 1. After updating the NoSQL DB, the data service device checks whether the queuing ID field of the data to be written is 1. If the queuing ID is 1, it indicates that the update task corresponding to the data to be written is already in the MQ and queuing is not needed. If the queuing ID is 0, it indicates that the update task for the piece of data is not in the MQ and needs to be added to the MQ. The data service device needs only to add the data ID of the data to be written to the MQ and determine whether the addition succeeds. When the data ID is successfully added the MQ, the data service device determines an update result to be successful update, and feeds back information that the data is successfully updated to the data access party.

As shown in FIG. 8, the operation in step S806 that the update task in the MQ is consumed to update the data in the relational DB includes the following operation: the data service data updates the queuing ID to in-queue in the NoSQL DB after adding the update task corresponding to the data to be written to the MQ. The data service device traverses update tasks in the MQ according to the queuing sequence. When traversing to the update task corresponding to the data to be written, the data service device firstly queries whether the target data corresponding to the data ID exists in the relational DB according to the data ID of the data to be written. If NO, a retry is made. If the target data corresponding to the data ID may not be identified after a preset number of retries, the update task is skipped, an alarm is sent out, and a next sequential update task is continued to be performed. If the target data exists, the data service device queries a corresponding target data content in the NoSQL DB according to the data ID in the update task. When a data version of the identified target data content is higher than a stored version of the original data content in the relational DB, the original data content corresponding to the data ID in the relational DB Is updated based on the identified target data content, and the queuing ID corresponding to the currently traversed data ID is updated to to-be-queued.

In the present embodiment, the relational DB is updated asynchronously by means of the MQ. Since update tasks in the MQ are continuously processed, the relational DB may actually implement quasi-real-time data update synchronization. Since the update tasks in the MQ are processed one by one, the relational DB is prevented from being overstressed by a large number of requests.

In an embodiment, the target data content includes a target version of the data to be written. The operation that an original data content corresponding to the data ID in the NoSQL DB is updated according to the target data content includes the following operations: a stored version of the original data content corresponding to the data ID in the NoSQL DB is determined; the original data content corresponding to the data ID in the NoSQL DB is updated according to the target data content when the target version is equal to the stored version; and the stored version is updated after successful update.

The data version is a field added to the DB by the data service device to execute the data access and storage methods provided by the present disclosure. Each piece of data has a corresponding stored version. In order to ensure the accuracy of the update sequence and solve sequence problems in updating the relational DB by the MQ, a data version field is added to each piece of data in the NoSQL DB and the relational DB to record data version information of each piece of data. The data version field needs to be added to the data tables of both the NoSQL DB and the relational DB. The data version field may specifically be a version number value, such as 0 and 1. When data is read, a data version number is read together. Then, one is added to the data version number for updating.

The data service device constructs an optimistic locking mechanism through the data version field and completes a write operation in the NoSQL DB based on the optimistic locking mechanism. Specifically, when the target data in the NoSQL DB is updated according to the data update request, the data service device compares a currently stored data version (hereinafter referred to as a stored version) of the original data content corresponding to the data ID in the data to be written in the NoSQL DB. When the data version (hereinafter referred to as a data version to be written) of the target data content in the data to be written is higher, update is performed, and one is added to the stored version after the update or insertion is completed. When the data version to be written is lower than the stored version, the write result is determined to be unsuccessful write, and information that the data fails to be written is returned to the data access party.

In the present embodiment, if a version number of submitted data is equal to a current version number of the table of the DB, the submitted data is updated. Otherwise, the submitted data is considered as outdated data. The optimistic locking mechanism ensures the accuracy of the data write operation.

In an embodiment, the data to be written includes data ID and a target data content. The operation that the data to be written is written in a DB includes the following operations: whether the data ID is stored in the relational DB is determined when the data write request is a data insertion request; the data to be written is inserted into the relational DB and the NoSQL DB when the data ID is not stored in the relational DB; and the data to be written is inserted into the relational DB when the data ID is stored in the relational DB, and the target data content is asynchronously updated from the NoSQL DB to the relational DB by MQ after successful insertion.

The data insertion request is a data request for instructing the data service device to execute an insertion operation on the data in the DB.

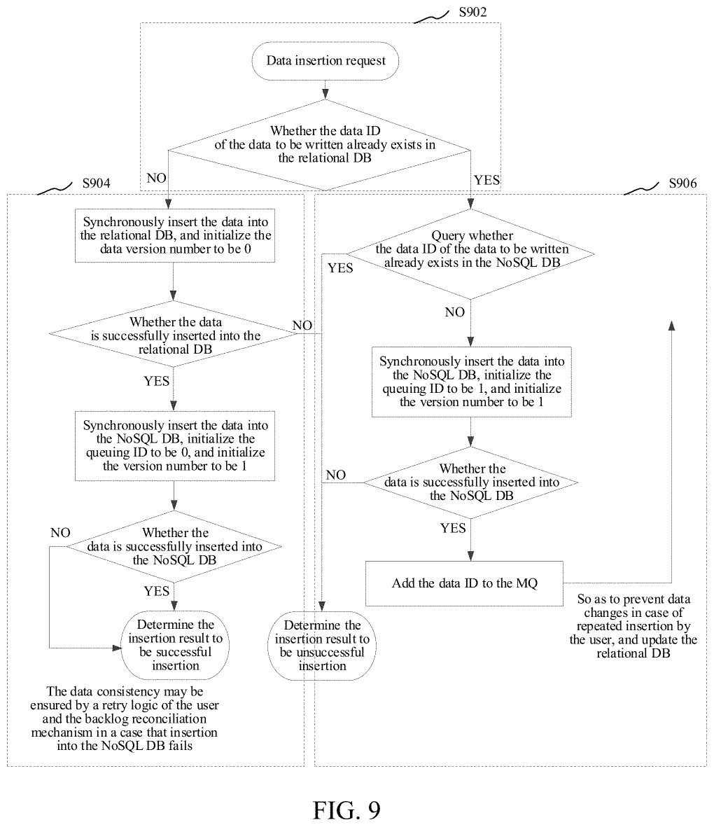

Specifically, referring to FIG. 9, a flowchart of performing quasi-real-time synchronization between a relational DB and a NoSQL DB in response to a data insertion request according to an embodiment is shown. As shown in FIG. 9, the step of responding to a data insertion request includes the following steps:

S902: When receiving the data insertion request, the data service device queries at first whether the data ID already exists in the relational DB according to the data ID of the data to be written in the data insertion request.

S904: If the data ID does not yet exist in the relational DB, indicating that the data ID is inserted for the first time, the data service device inserts the data to be written into the relational DB, and initializes the data version number of the data to be written in the relational DB to be 0.

If the data to be written is successfully inserted into the relational DB, the data service device, after successfully inserting the data to be written into the relational DB, inserts the data to be written into the NoSQL DB, and initializes the data version number of the data to be written in the NoSQL DB to be 0.

If the data to be written fails to be inserted into the relational DB or fails to be inserted into the NoSQL DB, the data service device returns information that insertion fails to the data access party.

S906: If the data ID already exists in the relational DB, indicating that the data is repeatedly inserted into the relational DB, the data service device queries whether the data ID already exists in the NoSQL DB according to the data ID.

If the data ID also exists in the NoSQL DB, indicating that the data is also repeatedly inserted into the NoSQL DB, the data service device returns prompting information of an insertion error to the data access party. During the insertion operation, two DBs are needed by insertion, and an insertion failure of any DB may cause the data access party to repeatedly initiate insertion. In the present embodiment, a piece of data is not repeatedly inserted when existing in the relational DB, and error information is returned when the data also exists in the NoSQL DB. Therefore, repeated data insertion may be avoided, and the data consistency may be ensured.

In an embodiment, the operation that the data to be written is inserted into the NoSQL DB when the data ID is stored in the relational DB includes the following operations: the data to be written is inserted into the NoSQL DB when the data ID is stored in the relational DB but not in the NoSQL DB; and a write result is determined to be unsuccessful write when the data ID is stored in the relational DB and the NoSQL DB.

If the data ID does not exist in the NoSQL DB, it indicates that the data is inserted into the NoSQL DB for the first time. The data service device inserts the data to be written into the NoSQL DB, and initializes the data version number of the data to be written in the NoSQL DB to be 0. Considering that the data may change, the data service device, after inserting the data to be written into the NoSQL DB, adds an update task of the data to be written to the MQ so as to update the corresponding target data stored in the relational DB. A specific update logic may refer to the above-mentioned embodiment, and will not be elaborated herein.

In an embodiment, as shown in FIG. 9, the data storage method further includes the following operation: a queuing ID of the data to be written is initialized to to-be-queued after inserting the data to be written into the relational DB and the NoSQL DB when the data write request is a data insertion request and the data ID is not stored in the relational DB. That is, when a piece of data to be written is inserted for the first time, an update task corresponding to the data to be written waits for being queued according to a normal update logic.

In an embodiment, as shown in FIG. 9, the data storage method further includes the following operation: the data ID of the data to be written is added to the MQ after inserting the data to be written into the NoSQL DB when the data ID is stored in the relational DB but not in the NoSQL DB, and the queuing ID of the data to be written is initialized to in-queue. That is, when a piece of data to be written is repeatedly inserted into the relational DB, an update task corresponding to the data to be written is immediately added to the MQ. Therefore, the real-time performance of data synchronization is improved.

In the present embodiment, since the NoSQL DB may endure a high-frequency and fast insertion operation, an insertion synchronization strategy of inserting into the relational DB first and then synchronously inserting into the NoSQL DB is adopted, and the data to be written is not asynchronously inserted into the NoSQL DB by means of the MQ. Therefore, the non-relational data does not need to bear the risk of synchronization failure caused by the asynchronous operation.

In an embodiment, the data storage method further includes the following operations: pieces of data in the relational DB is traversed; currently traversed data is inserted into the NoSQL DB when a data ID of the currently traversed data is not stored in the NoSQL DB; and when the data ID of the currently traversed data is stored in the NoSQL DB but corresponds to a different data content, a data content in the relational DB is updated according to the data content in the NoSQL DB.

Based on the above-mentioned quasi-real-time write synchronization strategy, the consistency of the data in the two DBs may be basically ensured. As shown in FIG. 7, in order to avoid the problem of data inconsistency caused by some extreme errors (such as continuous failure of data insertion into the NoSQL DB, or failure after multiple retries of message queue updates, etc.), the data service device ensures the final consistency of the data in the two DBs based on a preset backlog reconciliation mechanism.

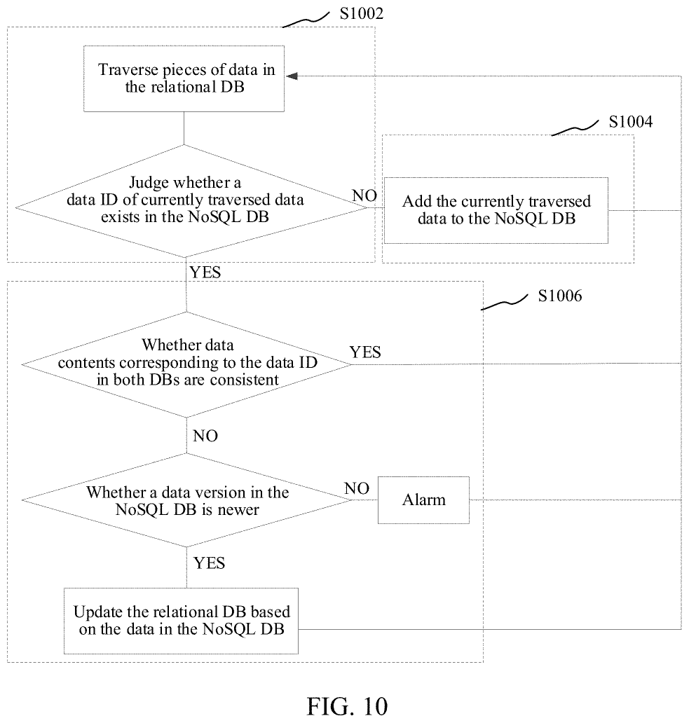

Specifically, referring to FIG. 10, a flowchart of backlog reconciliation in a relational DB and a NoSQL DB according to an embodiment is shown. As shown in FIG. 10, the backlog reconciliation of the data in the relational database and the non-relational database includes the following steps:

S1002: The data service device traverses pieces of data in the relational DB according to a target time frequency, and checks and queries whether a data ID of each traversed piece of data is simultaneously stored in the NoSQL DB.

In an embodiment, the data storage method further includes the following operations: a total data volume of data stored in the relational DB is statistically obtained according to a preset time frequency; and a target time frequency for traversing is determined according to the total data volume. The operation that traversing pieces of data in the relational DB includes the following operation: traversing pieces of data in the relational DB according to the target time frequency.

The backlog reconciliation mechanism is performed at regular intervals (e.g., 30 minutes) a script. An execution frequency (i.e., the target time frequency) of the backlog reconciliation script may be dynamically determined according to the total data volume of the data stored in the relational DB. It may be understood that the target time frequency is positively related to the total data volume.

S1004: If a data ID of a currently traversed piece of data is not stored in the NoSQL DB, the data service device adds the piece of data in the NoSQL DB, namely inserting the currently traversed data into the NoSQL DB, and initializes a data version of the newly added data to be 0.

S1006: If a data ID of a currently traversed piece of data is stored in the NoSQL DB, the data service device determines by comparison whether a data content corresponding to the data ID in the relational DB is consistent with that in the NoSQL DB. If YES, a next piece of data is continued to be traversed. If NO, the data service device determines by comparison whether a data version of the data content corresponding to the data ID in the NoSQL DB is higher than that of the data content in the relational DB. If YES, the data service device replaces the data content in the relational DB with that corresponding to the data ID in the NoSQL DB, and configures a queuing ID of the data corresponding to the data ID in the NoSQL DB to to-be-queued. The data is updated in the backlog reconciliation process completely based on the data in the NoSQL DB, without referring to the data version.

The backlog reconciliation mechanism may ensure the final consistency of the data in both DBs. Therefore, as shown in FIG. 8, in step S804, the update result may be determined to be successful update even when the data ID is not successfully added to the MQ.

In the present embodiment, further backlog reconciliation after the quasi-real-time synchronization between the two DBs may solve the problem of data inconsistency caused by some extreme errors and achieve the final consistency of the data.

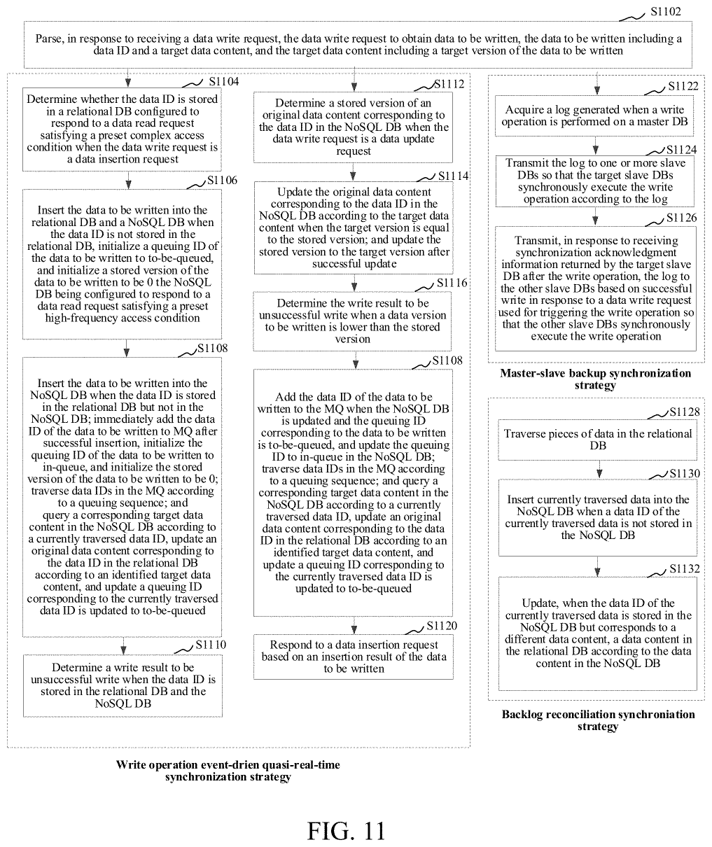

In one embodiment, as shown in FIG. 11, the data storage method provided by the present disclosure includes the following steps:

S1102: Parse, in response to receiving a data write request, the data write request to obtain data to be written, the data to be written including a data ID and a target data content, and the target data content including a target version of the data to be written.

S1104: Determine whether the data ID is stored in a relational DB configured to respond to a data read request satisfying a preset complex access condition when the data write request is a data insertion request.

S1106: Insert the data to be written into the relational DB and a NoSQL DB when the data ID is not stored in the relational DB, initialize a queuing ID of the data to be written to to-be-queued, and initialize a stored version of the data to be written to be 0, the NoSQL DB being configured to respond to a data read request satisfying a preset high-frequency access condition.

S1108: Insert the data to be written into the NoSQL DB when the data ID is stored in the relational DB but not in the NoSQL DB; immediately add the data ID of the data to be written to MQ after successful insertion, initialize the queuing ID of the data to be written to in-queue, and initialize the stored version of the data to be written to be 0; traverse data IDs in the MQ according to a queuing sequence; and query a corresponding target data content in the NoSQL DB according to a currently traversed data ID, update an original data content corresponding to the data ID in the relational DB according to an identified target data content, and update a queuing ID corresponding to the currently traversed data ID is updated to to-be-queued.

S1110: Determine a write result to be unsuccessful write when the data ID is stored in the relational DB and the NoSQL DB.

S1112: Determine a stored version of an original data content corresponding to the data ID in the NoSQL DB when the data write request is a data update request.

S1114: Update the original data content corresponding to the data ID in the NoSQL DB according to the target data content when the target version is equal to the stored version; and update the stored version to the target version after successful update.

S1116: Determine the write result to be unsuccessful write when a data version to be written is lower than the stored version.

S1118: Add the data ID of the data to be written to the MQ when the NoSQL DB is updated and the queuing ID corresponding to the data to be written is to-be-queued, and update the queuing ID to in-queue in the NoSQL DB; traverse each data ID in the MQ according to a queuing sequence; and query a corresponding target data content in the NoSQL DB according to a currently traversed data ID, update an original data content corresponding to the data ID in the relational DB according to an identified target data content, and update a queuing ID corresponding to the currently traversed data ID is updated to to-be-queued.

S1120: Respond to a data insertion request based on an insertion result of the data to be written.

S1122: Acquire a log generated when a write operation is performed on a master DB.

S1124: Transmit the log to one or more slave DBs so that the target slave DBs synchronously execute the write operation according to the log.

S1126: Transmit, in response to receiving synchronization acknowledgment information returned by the target slave DBs after the write operation, the log to the other slave DBs based on successful write in response to a data write request used for triggering the write operation so that the other slave DBs synchronously execute the write operation.

S1128: Traverse pieces of data in the relational DB.

S1130: Insert currently traversed data into the NoSQL DB when a data ID of the currently traversed data is not stored in the NoSQL DB.

S1132: Update, when the data ID of the currently traversed data is stored in the NoSQL DB but corresponds to a different data content, a data content in the relational DB according to the data content in the NoSQL DB.

In the data storage method, two storage manners are used with their advantages combined to ensure high data availability, and a quasi-real-time data storage access solution capable of ensuring the final consistency is designed. The solution may meet the data access requirements in high-concurrency business scenes and solve the performance problems of traditional relational DBs. For complex query and other scenes, a low-frequency complex query solution may be provided to overcome the disadvantages of the NoSQL DB in the complex query scene. A reliable data synchronization solution is provided to ensure the accuracy and consistency of the data. The final consistency of the data is ensured through the backlog reconciliation script. The business supporting capability of the data layer is improved greatly. The bottleneck of data access is solved. A strong foundation is provided for the stable development of the business.

During a data write operation, data is written in a DB at first, and then is synchronized from the DB to another DB. Since the data in the DB is obtained by synchronization, the consistency of the data in the two DBs may be ensured. Since the write and synchronization of the data are driven by a data write operation event, the real-time performance of data synchronization may be ensured. The relational DB supports low-concurrency data access operations, and may provide a capability of screening data according to a complex query condition. The NoSQL DB supports high-concurrency data access operations, and may provide a capability of screening data according to a simple query condition. On the premise of ensuring the consistency of the data in the two DBs, the advantages of the two storage technologies may be combined to distinguish sources for querying data according to the data access scene. That is, data is queried in the NoSQL DB in a high-concurrency data access scene, and data may be queried in the relational DB in a low-concurrency data access scene with a complex query condition. Therefore, both a high-concurrency data access request and a complex data access request may be satisfied, and the data access performance is improved.

It is to be understood that, although the steps in the flowcharts of FIG. 6 and FIG. 8 to FIG. 11 are sequentially displayed according to indication of arrows, the steps are not necessarily sequentially performed in the sequence indicated by the arrows. Unless clearly specified in this specification, there is no strict sequence limitation on the execution of the steps, and the steps may be performed in another sequence. Besides, at least some steps in FIG. 6 and FIG. 8 to FIG. 11 may include a plurality of steps or a plurality of stages, the steps or stages are not necessarily performed at a same moment and may be performed at different moments, the steps or stages are not necessarily sequentially performed, and the steps or stages and at least some of other steps or steps or stages of other steps may be performed in turn or alternately.

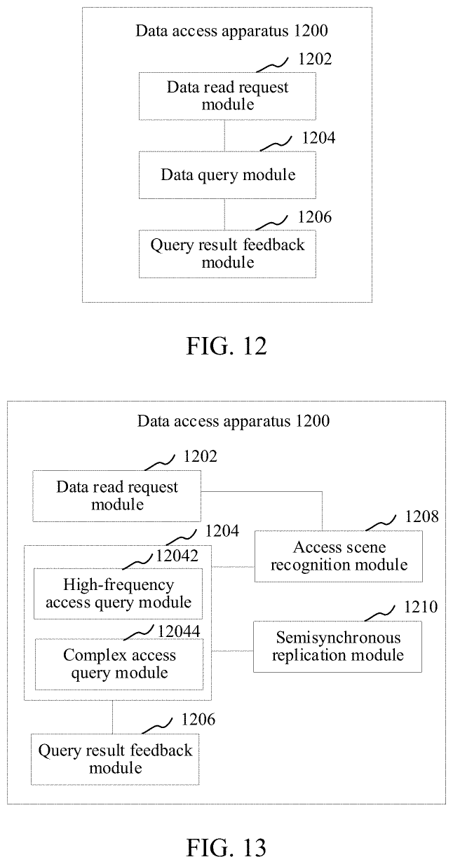

In an embodiment, as shown in FIG. 12, a data access apparatus 1200 is provided, which may be implemented as a part of a computer device by a software module, or a hardware module, or a combination of a software module and a hardware module. The apparatus specifically includes a data read request module 1202, a data query module 1204, and a query result feedback module 1206.

The data read request module 1202 is configured to parse, in response to receiving a data read request, the data read request to obtain a query condition.

The data query module 1204 is configured to query data satisfying the query condition in a NoSQL DB when the query condition satisfies a preset high-frequency access condition, and query data satisfying the query condition in a relational DB when the query condition satisfies a preset complex access condition, data stored in the NoSQL DB and the relational DB being consistent.

The query result feedback module 1206 is configured to respond to the data read request based on the queried data.

In an embodiment, as shown in FIG. 13, the data access apparatus 1200 further includes an access scene recognition module 1208, configured to determine that the query condition satisfies the preset high-frequency access condition when the query condition is a preset routing field, and determine that the query condition satisfies the preset complex access condition when the query condition includes a query field that is not the routing field.

In an embodiment, the NoSQL DB includes multiple distributed sub-DBs. As shown in FIG. 13, the data query module 1204 includes a high-frequency access query module 12042, configured to determine, when the query condition is a preset routing field, a distributed interval the routing field belongs to, and query data satisfying the query condition in a distributed sub-DB configured to store data in the distributed interval.

In an embodiment, there is one or more NoSQL DBs. The high-frequency access query module 12042 is further configured to query, when the query condition is a routing field, data satisfying the query condition in a NoSQL DB taking the routing field as a distributed storage basis.

In an embodiment, the relational DB includes a master DB and at least one slave DB. As shown in FIG. 13, the data query module 1204 further includes a complex access query module 12044, configured to initiate a query request to the master DB based on the query condition, determine one of the slave DBs as a current master DB when no query response of the master DB to the query request is received within a preset time, and query data satisfying the query condition in the current master DB.

In an embodiment, as shown in FIG. 13, the data access apparatus 1200 further includes a semi-synchronous replication module 1210, configured to acquire a log generated during a write operation over the master DB, transmit the log to one or more target slave DBs so that the target slave DBs synchronously execute the write operation according to the log, and transmit, in response to receiving synchronization acknowledgment information returned by the target slave DBs after the write operation, the log to the other slave DBs based on successful write in response to a data write request used for triggering the write operation.

According to the data access apparatus, the relational DB supports low-concurrency data access operations, and may provide a capability of screening data according to a complex query condition. The NoSQL DB supports high-concurrency data access operations, and may provide a capability of screening data according to a simple query condition. By combining the advantages of the two storage technologies and ensuring the consistency of the data in the two DBs, sources for querying data are distinguished according to the data access scene. That is, data is queried in the NoSQL DB in a high-concurrency data access scene, and data may be queried in the relational DB in a low-concurrency data access scene with a complex query condition. Therefore, both a high-concurrency data access request and a complex data access request may be satisfied, and the data access performance is improved.

For a specific limitation on the data access apparatus, reference is made to the limitation on the data access method above, and details are not described herein again. The modules in the foregoing data access apparatus may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

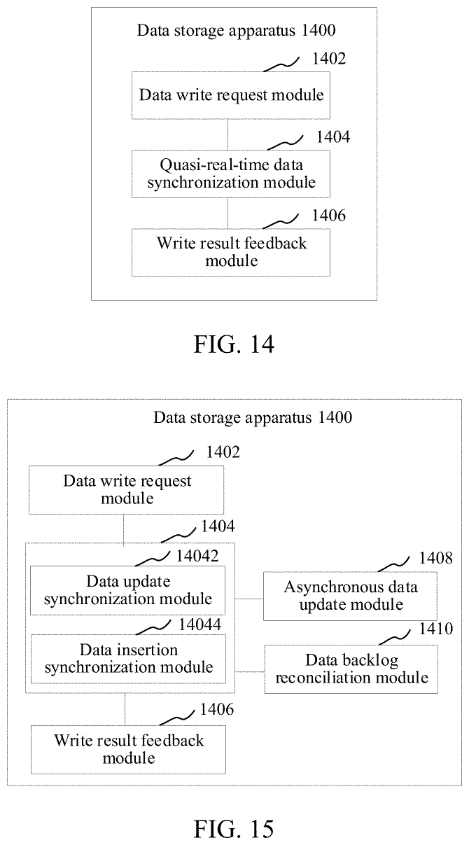

In an embodiment, as shown in FIG. 14, a data storage apparatus 1400 is provided, which may be implemented as a part of a computer device by a software module, or a hardware module, or a combination of a software module and a hardware module. The apparatus specifically includes a data write request module 1402, a quasi-real-time data synchronization module 1404, and a write result feedback module 1406.

The data write request module 1402 is configured to parse, in response to receiving a data write request, the data write request to obtain data to be written.

The quasi-real-time data synchronization module 1404 is configured to write the data to be written in a DB, and synchronize the data to be written from the DB to another DB, a type of the DB including a relational DB and a NoSQL DB, the NoSQL DB being configured to respond to a data read request satisfying a preset high-frequency access condition, and the relational DB being configured to respond to a data read request satisfying a preset complex access condition.

The write result feedback module 1406 is configured to respond to the data write request based on a write result of the data to be written.

In an embodiment, the data to be written includes data ID and a target data content. As shown in FIG. 15, the quasi-real-time data synchronization module 1404 includes a data update synchronization module 14042, configured to update an original data content corresponding to the data ID in the NoSQL DB according to the target data content when the data write request is a data update request. Synchronizing the data to be written from the DB to another DB includes asynchronously updating the target data content is from the NoSQL DB to the relational DB by MQ after the update of the NoSQL DB.

In an embodiment, the target data content includes a target version of the data to be written. The data update synchronization module 14042 is further configured to determine a stored version of an original data content corresponding to the data ID in the NoSQL DB when the data write request is a data update request, update the original data content corresponding to the data ID in the NoSQL DB according to the target data content when the target version is equal to the stored version, update the stored version to the target version after successful update, and determine the write result to be unsuccessful write when a data version to be written is lower than the stored version.

In an embodiment, the data to be written includes data ID and a target data content. As shown in FIG. 15, the quasi-real-time data synchronization module 1404 further includes a data insertion synchronization module 14044, configured to determine whether the data ID is stored in the relational DB when the data write request is a data insertion request, insert the data to be written into the relational DB and the NoSQL DB when the data ID is not stored in the relational DB, insert the data to be written into the relational DB when the data ID is stored in the relational DB, and asynchronously update the target data content from the NoSQL DB to the relational DB by MQ after successful insertion.

In an embodiment, the data insertion synchronization module 14044 is further configured to insert the data to be written into the NoSQL DB when the data ID is stored in the relational DB but not in the NoSQL DB; and determine a write result to be unsuccessful write when the data ID is stored in the relational DB and the NoSQL DB.

In an embodiment, the data update synchronization module 14042 is further configured to add the data ID of the data to be written to the MQ when the NoSQL DB is updated and the queuing ID corresponding to the data to be written is to-be-queued, and update the queuing ID to in-queue in the NoSQL DB; traverse data IDs in the MQ according to a queuing sequence; and query a corresponding target data content in the NoSQL DB according to a currently traversed data ID, update an original data content corresponding to the data ID in the relational DB according to an identified target data content, and update a queuing ID corresponding to the currently traversed data ID is updated to to-be-queued.

In an embodiment, the data storage apparatus 1400 further includes an asynchronous data update module 1408, configured to initialize a queuing ID of the data to be written to to-be-queued after inserting the data to be written into the relational DB and the NoSQL DB when the data write request is a data insertion request and the data ID is not stored in the relational DB, add the data ID of the data to be written to the MQ after inserting the data to be written into the NoSQL DB when the data ID is stored in the relational DB but not in the NoSQL DB, and initialize the queuing ID of the data to be written to in-queue.

In an embodiment, as shown in FIG. 15, the data storage apparatus 1400 further includes a data backlog reconciliation module 1410, configured to traverse each piece of data in the relational DB, insert currently traversed data into the NoSQL DB when a data ID of the currently traversed data is not stored in the NoSQL DB, and update, when the data ID of the currently traversed data is stored in the NoSQL DB but corresponds to a different data content, a data content in the relational DB according to the data content in the NoSQL DB.

According to the data storage apparatus, during a data write operation, data is written in a DB at first, and then is synchronized from the DB to another DB. Since the data in the DB is obtained by synchronization, the consistency of the data in the two DBs may be ensured. Since the write and synchronization of the data are driven by a data write operation event, the real-time performance of data synchronization may be ensured. The relational DB supports low-concurrency data access operations, and may provide a capability of screening data according to a complex query condition. The NoSQL DB supports high-concurrency data access operations, and may provide a capability of screening data according to a simple query condition. On the premise of ensuring the consistency of the data in the two DBs, the advantages of the two storage technologies may be combined to distinguish sources for querying data according to the data access scene. That is, data is queried in the NoSQL DB in a high-concurrency data access scene, and data may be queried in the relational DB in a low-concurrency data access scene with a complex query condition. Therefore, both a high-concurrency data access request and a complex data access request may be satisfied, and the data access performance is improved.

For some embodiments on the data access apparatus, reference is made to the limitation on the data access method above, and details are not described herein again. The modules in the foregoing data access apparatus may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules. Further, each module can be part of an overall module that includes the functionalities of the module.

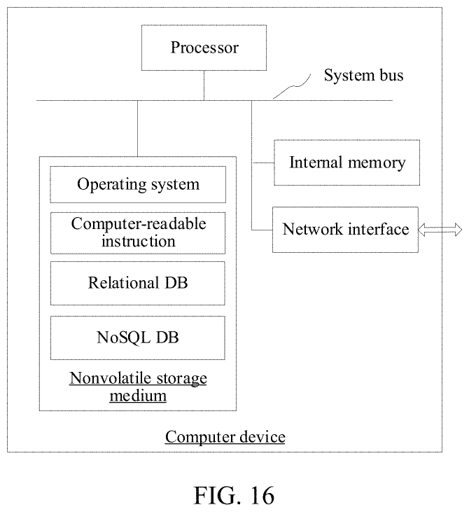

In an embodiment, a computer device is provided. The computer device may be a server, and an internal structure diagram thereof may be shown in FIG. 16. The computer device includes a processor, a memory, and a network interface connected through a system bus. The processor of the computer device is configured to provide computing and control capabilities. The memory of the computer device includes a non-volatile storage medium and an internal memory. The non-volatile storage medium stores an operating system, computer-readable instructions, and a database. The internal memory provides an environment for running of the operating system and the computer-readable instructions in the non-volatile storage medium. The DB of the computer device includes a relational DB and a NoSQL DB, which store consistent data. The network interface of the computer device is configured to communicate with an external terminal through a network connection. The computer-readable instructions, when executed by a processor, implement data access and storage methods.

A person skilled in the art may understand that the structure shown in FIG. 16 is only a block diagram of a partial structure related to the solution of the present disclosure and does not constitute a limitation the computer device to which the solution of the present disclosure is applied. The computer device may specifically include more or fewer components than those shown in the figure, or some components may be combined, or a different component deployment may be used.

In an embodiment, a computer device is provided, including a memory and a processor, the memory storing computer-readable instructions, the processor, when executing the computer-readable instructions, implementing the steps in the foregoing method embodiments.

In an embodiment, a computer-readable storage medium is provided, storing computer-readable instructions, the computer-readable instructions, when executed by a processor, implementing the steps in the foregoing method embodiments.

In an embodiment, a computer program product or a computer-readable instruction is provided, the computer program product or the computer-readable instruction includes computer-readable instructions, and the computer-readable instructions are stored in the computer-readable storage medium. The processor of the computer device reads the computer-readable instructions from the computer-readable storage medium, and the processor executes the computer-readable instructions, to cause the computer device to perform the steps in the method embodiments.

A person of ordinary skill in the art may understand that all or some of the procedures of the methods of the foregoing embodiments may be implemented by computer-readable instructions instructing relevant hardware. The computer-readable instructions may be stored in a non-volatile computer-readable storage medium. When the computer-readable instructions are executed, the procedures of the embodiments of the foregoing methods may be included. Any reference to a memory, a storage, a database, or another medium used in the embodiments provided in the present disclosure may include at least one of a non-volatile memory and a volatile memory. The non-volatile memory may include a read-only memory (ROM), a magnetic tape, a floppy disk, a flash memory, an optical memory, and the like. The volatile memory may include a random access memory (RAM) or an external cache. For the purpose of description instead of limitation, the RAM is available in a plurality of forms, such as a static RAM (SRAM) or a dynamic RAM (DRAM).

The technical features in the above embodiments may be combined in different manners to form other embodiments. For concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of the present disclosure specifically and in detail, but cannot be construed as a limitation to the patent scope of the present disclosure. It should be noted that for a person of ordinary skill in the art, several transformations and improvements can be made without departing from the idea of the present disclosure. These transformations and improvements belong to the protection scope of the present disclosure. Therefore, the protection scope of the patent of the present disclosure shall be subject to the appended claims.

What is claimed is:

1. A data operation method, executed by a computer device, the method comprising:
parsing, in response to receiving a data read request, the data read request to obtain a query condition;
querying data satisfying the query condition in a not only structured query language (NoSQL) database (DB) when the query condition satisfies a preset high-frequency access condition;
querying data satisfying the query condition in a relational DB when the query condition satisfies a preset complex access condition, data stored in the NoSQL DB and the relational DB being consistent; and
responding to the data read request based on the queried data.

2. The method according to claim 1, further comprising:
determining that the query condition satisfies the preset high-frequency access condition when the query condition is a routing field; and
determining that the query condition satisfies the preset complex access condition when the query condition comprises a query field that is not the routing field.

3. The method according to claim 1, wherein the NoSQL DB comprises multiple distributed sub-DBs; and the querying data satisfying the query condition in a NoSQL DB when the query condition satisfies a preset high-frequency access condition comprises:
determining, when the query condition is a routing field, a distributed interval the routing field belongs to; and
querying data satisfying the query condition in a distributed sub-DB configured to store data in the distributed interval.

4. The method according to claim 1, wherein there is one or more NoSQL DBs; and the querying data satisfying the query condition in a NoSQL DB when the query condition satisfies a preset high-frequency access condition comprises:
querying, when the query condition is a routing field, data satisfying the query condition in one of the one or more NoSQL DB that uses the routing field as a distributed storage basis.

5. The method according to claim 1, wherein the relational DB comprises master DB and at least one slave DB; and the querying data satisfying the query condition in a relational DB comprises:
initiating a query request to the master DB based on the query condition;
determining one of the slave DBs as a current master DB when no query response of the master DB to the query request is received within a preset time; and
querying data satisfying the query condition in the current master DB.

6. The method according to claim 5, further comprising:
acquiring a log generated during a write operation over the master DB;
transmitting the log to one or more target slave DBs so that the target slave DBs synchronously execute the write operation according to the log; and
transmitting, in response to receiving synchronization acknowledgment information returned by the target slave DBs after the write operation, the log to the other slave DBs based on successful write in response to a data write request used for triggering the write operation.

7. The method according to claim 1, further comprising:
parsing, in response to receiving a data write request, the data write request to obtain data to be written;
writing the data to be written in a first DB, the first DB being one of the NoSQL DB and the relational DB;
synchronizing the data to be written from the first DB to a second DB, the second DB being the other one of the NoSQL DB and the relational DB; and
responding to the data write request based on a write result of the data to be written.

8. The method according to claim 7, wherein the data to be written comprises a data Identifier (ID) and a target data content; the writing the data to be written in a first DB comprises:
updating an original data content corresponding to the data ID in the NoSQL DB according to the target data content when the data write request is a data update request; and
the synchronizing the data to be written from the first DB to the second DB comprises:
asynchronously updating the target data content from the NoSQL DB to the relational DB by messagequeuing (MQ) after the update of the NoSQL DB.

9. The method according to claim 8, wherein the target data content comprises a target version of the data to be written; and the updating an original data content corresponding to the data ID in the NoSQL DB according to the target data content comprises:
determining a stored version of the original data content corresponding to the data ID in the NoSQL DB;
updating the original data content corresponding to the data ID in the NoSQL DB according to the target data content when the target version is equal to the stored version; and
updating the stored version after successful update.

10. The method according to claim 7, wherein the data to be written comprises a data ID and a target data content; and the writing the data to be written in a first DB comprises:
determining whether the data ID is stored in the relational DB when the data write request is a data insertion request;
inserting the data to be written into the relational DB and the NoSQL DB when the data ID is not stored in the relational DB; and
inserting the data to be written into the relational DB when the data ID is stored in the relational DB, and asynchronously updating the target data content from the NoSQL DB to the relational DB by MQ after successful insertion.

11. The method according to claim 10, wherein the inserting the data to be written into the NoSQL DB when the data ID is stored in the relational DB comprises:
inserting the data to be written into the NoSQL DB when the data ID is stored in the relational DB but not in the NoSQL DB; and
determining a write result to be unsuccessful write when the data ID is stored in the relational DB and the NoSQL DB.

12. The method according to claim 8, wherein the asynchronously updating the target data content from the NoSQL DB to the relational DB by MQ comprises:
adding the data ID of the data to be written to the MQ when a queuing ID corresponding to the data to be written is to-be-queued, and updating the queuing ID to in-queue in the NoSQL DB;
traversing data IDs in the MQ according to a queuing sequence; and
querying a corresponding target data content in the NoSQL DB according to a currently traversed data ID, updating an original data content corresponding to the data ID in the relational DB according to an identified target data content, and updating a queuing ID corresponding to the currently traversed data ID to to-be-queued.

13. The method according to claim 8, further comprising:
initializing a queuing ID of the data to be written to to-be-queued after inserting the data to be written into the relational DB and the NoSQL DB when the data write request is a data insertion request and the data ID is not stored in the relational DB; and
adding the data ID of the data to be written to the MQ after inserting the data to be written into the NoSQL DB when the data ID is stored in the relational DB but not in the NoSQL DB, and initializing the queuing ID of the data to be written to in-queue.

14. The method according to claim 10, further comprising:
traversing pieces of data in the relational DB;
inserting currently traversed data into the NoSQL DB when a data ID of the currently traversed data is not stored in the NoSQL DB; and
updating, when the data ID of the currently traversed data is stored in the NoSQL DB but corresponds to a different data content, a data content in the relational DB according to the data content in the NoSQL DB.

15. The method according to claim 14, further comprising:
obtaining statistics about a total data volume of data stored in the relational DB according to a preset time frequency, and
determining a target time frequency for traversing according to the total data volume; and
the traversing pieces of data in the relational DB comprises:
traversing the pieces of data in the relational DB according to the target time frequency.

16. A computer device, comprising a memory storing a computer-readable instruction and one or more processors, when executing the computer-readable instruction, the one or more processors being configured to:
parse, in response to receiving a data read request, the data read request to obtain a query condition;
query data satisfying the query condition in a not only structured query language (NoSQL) database (DB) when the query condition satisfies a preset high-frequency access condition, and query data satisfying the query condition in a relational DB when the query condition satisfies a preset complex access condition, data stored in the NoSQL DB and the relational DB being consistent; and
respond to the data read request based on the queried data.

17. The device according to claim 16, wherein the processor is further configured to determine that the query condition satisfies the preset high-frequency access condition when the query condition is a routing field, and determine that the query condition satisfies the preset complex access condition when the query condition comprises a query field that is not the routing field.

18. The device according to claim 16, wherein the processor is further configured to:
parse, in response to receiving a data write request, the data write request to obtain data to be written;
write the data to be written in a first DB, the first DB being one of the NoSQL DB and the relational DB;
synchronize the data to be written from the first DB to a second DB, the second DB being the other one of the NoSQL DB and the relational DB; and
respond to the data write request based on a write result of the data to be written.

19. The device according to claim 18, wherein the data to be written comprises a data Identifier (ID) and a target data content;
when writing the data to be written in the first DB, the processor is further configured to: update an original data content corresponding to the data ID in the NoSQL DB according to the target data content when the data write request is a data update request; and
when synchronizing the data to be written from the first DB to the second DB, the processor is further configured to: asynchronously update the target data content from the NoSQL DB to the relational DB by messagequeuing (MQ) after the update of the NoSQL DB.

20. One or more non-transitory computer-readable storage media storing computer-readable instructions, the computer-readable instructions, when executed by one or more processors, causing the one or more processors to execute:
parsing, in response to receiving a data read request, the data read request to obtain a query condition;
querying data satisfying the query condition in a not only structured query language (NoSQL) database (DB) when the query condition satisfies a preset high-frequency access condition;
querying data satisfying the query condition in a relational DB when the query condition satisfies a preset complex access condition, data stored in the NoSQL DB and the relational DB being consistent; and
responding to the data read request based on the queried data.
